(19) United States
(12) Patent Application Publication
(10) Pub. No.: US 2023/0146819 A1
(43) Pub. Date: May 11, 2023

(54) FOURIER NEURAL OPERATOR NETWORKS WITH SUB-SAMPLED NON-LINEAR TRANSFORMATIONS

(71) Applicant: Microsoft Technology Licensing, LLC, Redmond, WA (US)

(72) Inventors: Philipp Andre WITTE, Seattle, WA (US); Tugrul KONUK, Golden, CO (US)

(73) Assignee: Microsoft Technology Licensing, LLC, Redmond, WA (US)

(21) Appl. No.: 17/688,543

(22) Filed: Mar. 7, 2022

Related U.S. Application Data
(60) Provisional application No. 63/276,754, filed on Nov. 8, 2021.

(51) Int. Cl. G06F 30/27; G06T 3/40; G06T 5/10

(52) U.S. Cl. CPC G06F 30/27; G06T 3/4046; G06T 5/10; G06T 2207/20056; G06T 2207/20084; G06F 2111/10

(57) ABSTRACT

In a numerical simulation, input data expressed in at least a first domain is received. The input data is transformed to generate frequency modes of the input data in frequency domain. The transformed data is down-sampled to retain a subset of the frequency modes in the frequency domain. The down-sampled data is successively processed with one or more stages of a neural network to generate a down-sampled output in the frequency domain. The processing includes applying, in each stage of the one or more stages, a non-linear transformation to the subset of the frequency modes. The down-sampled output is then up-sampled to generate an up-sampled output corresponding to the frequency modes in the frequency domain, and the up-sampled output is transformed from the frequency domain to the at least the first domain to generate a result of the numerical simulation.

### CROSS-REFERENCE TO RELATED APPLICATIONS

This application claims the benefit of priority to U.S. Provisional Application No. 63/276,754, entitled “Fourier Neural Operator Networks with Sub-Sampled Non-Linear Transformations,” filed Nov. 8, 2021, the entire disclosure of which is hereby incorporated by reference herein in its entirety.

### BACKGROUND

Numerical simulations are utilized in a wide variety of applications that involve solving differential equations that model physical phenomena, such as wave propagation, fluid flow, heat transfer and the like. Conventionally, such differential equations are solved numerically by i) discretizing the differential equation using techniques such as finite differences (FD), finite volumes (FV) or finite elements (FEM) and ii) solving the discretized differential equation using numerical solvers. Depending on the mathematical nature of the underlying equations (e.g., linear or non-linear, condition number, etc.), a variety of solvers are used to solve the differential equations. Such solvers include, among others, Gauss Newton, Jacobi, Gauss-Seidel or forward/backward substitution, for example. Numerical solvers must typically satisfy a set of stability conditions that determine the maximum possible grid size for discretization and time stepping intervals for time-dependent problems. Stability conditions, in turn, determine the computational cost of numerical simulators. Most numerical simulators are computationally very expensive and cannot be scaled to problem sizes of interest for many applications.

More recently, data-driven simulations using deep neural networks have emerged as an alternative approach to numerical simulations based on physical equations. In these artificial intelligence (AI)-driven approaches, a deep (e.g., convolutional) neural network (DNN) is trained to approximate the solution of a numerical simulator. Most data-driven approaches are based on supervised learning in which the DNN learns the mapping between sets of numerical models and data that has been simulated using numerical solvers. One specific instance of a DNN for numerical simulations utilizes Fourier Neural Operators (FNO). An FNO typically comprises a plurality of frequency domain layers that operate on a plurality of frequency modes of one or more input parameters. Each frequency domain layer includes a forward Fourier Transform (F) to transform an input to the frequency domain. In the frequency domain, a linear multiplication is performed to apply learnable weights to a down-sampled subset of the frequency modes of the input in the frequency domain. Then, up-sampling is performed to generate an output having dimensions of the original number of modes, and an inverse Fourier transform is applied to obtain an output in the time domain. A non-linear activation function is applied to introduce non-linearity to the output in the time domain. The process of performing Fourier transform, linear multiplication, up-sampling, inverse Fourier transform, and introducing non-linearity in the time domain is performed in each layer of the FNO network. While FNOs have shown great promise in approximating the solution operators for a variety of differential equations, the multiple Fourier transformations that need to be performed on full-dimensional data in each layer of an FNO results in large computational costs.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure are directed to improving image processing in computer vision applications.

In an aspect, a method for performing a numerical simulation includes receiving input data expressed in at least a first domain. The method also includes transforming the input data from the first domain to frequency domain, including generating a plurality of frequency modes of the input data in the frequency domain, and down-sampling the plurality of frequency modes to generate down-sampled input data in the frequency domain, the down-sampled input data including a subset of the plurality of frequency modes. The method further includes successively processing the down-sampled input data with one or more stages of a neural network to generate a down-sampled output in the frequency domain, the processing including applying, in each stage of the one or more stages, a non-linear transformation to the subset of the plurality of frequency modes. The method additionally includes up-sampling the down-sampled output to generate an up-sampled output corresponding to the plurality of frequency modes in the frequency domain, and transforming the up-sampled output from the frequency domain to the at least first domain to generate a result of the numerical simulation.

In another aspect, a system is provided. The system includes one or more computer readable storage media, and program instructions stored on the one or more computer readable storage media that, when executed by at least one processor, cause the at least one processor to perform operations. The operations include receiving training data for training a neural network to perform numerical simulations to model a physical phenomenon, the training data determined based on a solution of one or more differential equations that model the physical phenomenon. The operations also include training a neural network, based on the training data, to perform numerical simulations modeling the physical phenomenon, wherein the neural network includes multiple frequency domain stages configured to apply non-linear transformations to sub-sampled input data in frequency domain. The operations additionally include receiving input data for a numerical simulation, the input data expressed in at least a first domain, and transforming the input data from the first domain to frequency domain, including generating a plurality of frequency modes of the input data in the frequency domain. The operations further include down-sampling the plurality of frequency modes to generate down-sampled input data in the frequency domain, the down-sampled input data including a subset of the plurality of frequency modes, and successively processing the down-sampled input data with the multiple stages of the neural network to generate a down-sampled output in the frequency domain, the processing including applying, in each stage of the multiple stages, the non-linear transformation to the subset of the plurality of frequency modes. The operations further still include up-sampling the down-sampled output to generate an up-sampled output corresponding to the plurality of frequency modes in the frequency domain. The operations also include transforming the up-sampled output from the frequency domain to the at least the first domain to generate a result of the numerical simulation.

In still another aspect, a computer-readable storage medium is provided. The computer-readable storage medium stores instructions that when executed by at least one processor cause a computer system to perform operations. The operations include receiving input data expressed in at least a first domain. The operations also include transforming the input data from the first domain to frequency domain, including generating a plurality of frequency modes of the input data in the frequency domain. The operations further include down-sampling the plurality of frequency modes to generate down-sampled input data in the frequency domain, the down-sampled input data including a subset of the plurality of frequency modes. The operations further still include successively processing the down-sampled input data with one or more stages of a neural network to generate a down-sampled output in the frequency domain, the processing including applying, in each stage of the one or more stages, a non-linear transformation to the subset of the plurality of frequency modes. The operations additionally include up-sampling the down-sampled output to generate an up-sampled output corresponding to the plurality of frequency modes in the frequency domain, and transforming the up-sampled output from the frequency domain to the at least the first domain to generate a result of the numerical simulation.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of an example system in which a frequency domain neural network with sub-sampled non-linear transformations may be utilized, in accordance with aspects of the present disclosure.

FIG. 2 is a block diagram depicting an example implementation of the frequency domain neural network with sub-sampled non-linear transformations of FIG. 1, in accordance with aspects of the present disclosure.

FIG. 3 is a block diagram depicting an example implementation of a frequency domain layer with sub-sampled non-linear transformations, in accordance with aspects of the present disclosure.

FIG. 4 is a block diagram depicting an example implementation of a frequency domain layer with sub-sampled non-linear transformations in more detail, in accordance with aspects of the present disclosure.

FIG. 5 is a block diagram depicting an example a system for training a frequency domain neural network with sub-sampled non-linear transformations, in accordance with aspects of the present disclosure.

FIG. 6 is a plot depicting training conversion of a frequency domain neural network with sub-sampled non-linear transformations, in accordance with aspects of the present disclosure.

FIG. 7 is a diagram depicting operation of a frequency domain neural network with sub-sampled non-linear transformations, in accordance with aspects of the present disclosure

FIG. 8 is a block diagram of an example method of performing a numerical simulation, in accordance with aspects of the present disclosure.

FIG. 9 is a block diagram illustrating physical components (e.g., hardware) of a computing device with which aspects of the disclosure may be practiced.

FIGS. 10A-10B illustrate a mobile computing device with which aspects of the disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects disclosed herein may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, a frequency domain neural network is trained and used to perform numerical simulations. The frequency domain neural network may perform a frequency transformation to transform input data from a time and/or spatial domain to frequency domain, generating a plurality of frequency modes of the input data in the frequency domain. Dimensionality of the input data in the frequency domain may be reduced by sub-sampling the plurality of modes in the frequency domain. The down-sampled data may be processed with one or more stages of a neural network to generate a down-sampled output in the frequency domain. The processing may include applying, in each stage of the one or more stages, a non-linear transformation to the subset of the plurality of frequency modes. The down-sampled output at the last stage of the one or more stages may be up-sampled to generate an up-sampled output corresponding to the plurality of frequency modes in the frequency domain, and the up-sampled output may be transformed from the frequency domain to the time and/or frequency domain to generate a result of the numerical simulation. Because only a single frequency domain transform is performed on the full dimensional input data and only one inverse frequency transform is performed on the full dimensional output data, the frequency domain neural network of the present disclosure may be implemented with less computational cost as compared to a conventional frequency domain neural network, such as a conventional FNO. The reduced computational cost may in turn allow the frequency domain neural network of the present disclosure to scale to numerical simulations with increased dimensionality, such as three-dimensional or four-dimensional numerical simulations.

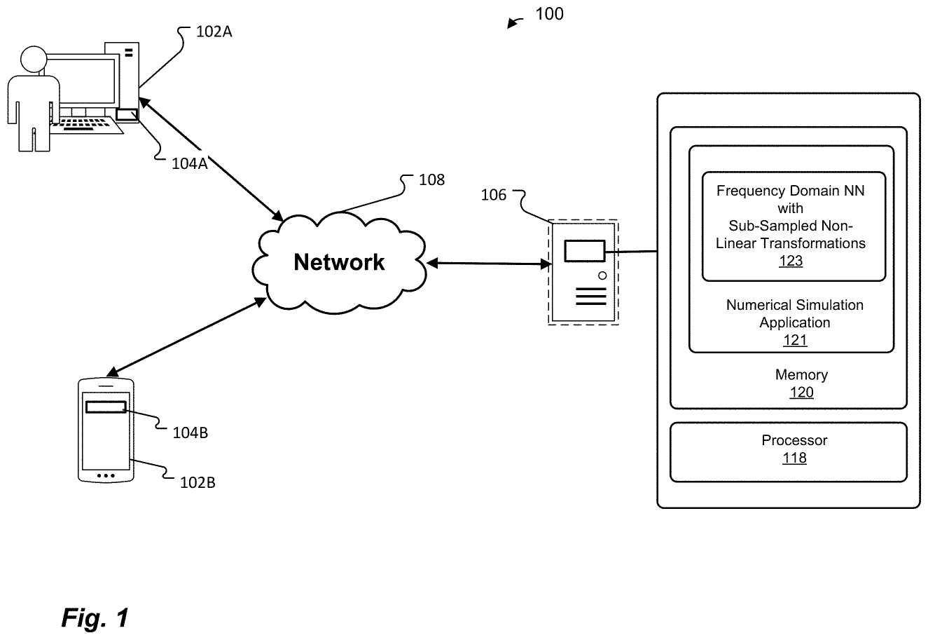

FIG. 1 is a block diagram of an example system 100 in which a frequency domain neural network with sub-sampled non-linear transformations may be utilized, in accordance with aspects of the present disclosure. The system 100 may include a plurality of user devices 102 (i.e., 102A and 102B) that may be configured to run or otherwise execute client applications 104. The user devices 102 may include, but are not limited to, laptops, tablets, smartphones, and the like. The client applications 104 (i.e., 104A and 104B) may allow users of the user devices 102 to perform numerical simulations. For example, client applications 104 may comprise a user interface that may allow a user of a user device 102 to enter input parameters for the numerical simulation, to view output of the numerical simulation, etc. In some examples, the applications 104 may include web applications, where such applications 104 may run or otherwise execute instructions within web browsers. In some examples, the applications 104 may additionally or alternatively include native client applications residing on the user devices 102.

The user devices 102 may be communicatively coupled to a computing device 106 via a network 108. The computing device 106 may be a server or other computing platform generally accessible via the network 108. The computing device 106 may be a single computing device as illustrated in FIG. 1, or the computing device 106 may comprise multiple computing devices (e.g., multiple servers) that may execute the applications in a distributed manner. The network 108 may be a wide area network (WAN) such as the Internet, a local area network (LAN), or any other suit able type of network. The network 108 may be single network or may be made up of multiple different networks, in some examples.

The computing device 106 may include at least one processor 118 and a computer-readable memory 120 that stores a numerical simulation application 121 in the form of computer-readable instructions, for example, that may be executable by the least one processor 118. Computer readable memory 120 may include volatile memory to store computer instructions and data on which the computer instructions operate at runtime (e.g., Random Access Memory or RAM) and, in an embodiment, persistent memory such as a hard disk, for example. The numerical simulation application 121 may generally be configured utilize a data-driven trained model (e.g., a frequency domain neural network as described herein) to model a physical phenomenon that may typically be modeled using differential equations, such as ordinary differential equations (ODE) or partial differential equations (PDE). For example, in an industrial carbon dioxide (CO₂) storage scenario, the numerical simulation application 121 may model the flow or propagation of CO₂ in a CO₂ injection site used to trap CO₂ in the sub-surface in supercritical state. In this case, the model may represent two-phase flow simulation of CO₂ in the supercritical state. As another example, the numerical simulation application 121 may model propagation or strength of a Wi-Fi signal in a physical space such as a building or a room. In this case, the numerical simulation application 121 may simulate wave propagation that may be modeled by highly oscillatory differential equations, such as Helmholtz equations. Generally, in various aspects, the numerical simulation application 121 may be configured to perform various types of numerical simulations, such as numerical simulations that model wave propagation (e.g., Helmholtz equations), fluid flow, heat transfer, electric charge (e.g., Poisson's equations), etc.

The numerical simulation application 121 may include a frequency domain neural network 123. As will be explained in more detail below, the frequency domain neural network 123 may perform one or more non-linear transformations on sub-sampled frequency domain input data that may be successively processed (e.g., operated on) by successive stages or layers of the frequency domain neural network 123. For example, as will be described in more detail below, the frequency domain neural network 123 may perform quadratic spectral convolution of learnable weights with data having sub-sampled frequency domain dimensionality. In other aspects, non-linear transformations other than quadratic transformations may be performed on the sub-sampled frequency domain input data.

The numerical simulator application 121 may be configured to train the frequency domain neural network 123 to infer, from input data, results of differential equations that model a physical phenomenon. The input data may be multi-dimensional data, such as input data corresponding to a mesh grid of values describing input parameters in spatial and/or temporal domains. As an example, in a CO₂ storage application, the input data may include, but not limited to, one or more of permeability and/or porosity of the sub-terrain (e.g., rock or earth) into which CO₂ is to be injected, control parameters of an injection well used for CO₂ injection, such as the location of the well, the depth of the well, the well perforation, the well pressure, etc. In an aspect, the frequency domain neural network 123 may be trained using supervised learning in which the frequency domain neural network 123 may learn mappings between a set of numerical model parameters and output data that has been simulated using numerical solvers modeling differential equations. As an example, in the CO₂ storage application, the frequency domain neural network 123 may be trained to infer saturation and/or pressure distribution of CO₂ as a function of time, for example. In an aspect, the frequency domain neural network 123 may be mesh-invariant in that once the frequency domain neural network 123 is trained on input data corresponding to a particular mesh grid, the frequency domain neural network 123 may be used to infer result from input data corresponding to a different mesh grid. The numerical simulator application 121 may also be configured to receive input parameters from a user device 102 via the network 108, and to run a numerical simulation using the trained frequency domain neural network 123 to generate an output simulating results of the differential equations modeling the physical phenomenon. The simulated results may be provided from the server 106 to the user device 102 via the network 108, and may be displayed, in some manner, to a user of the user device 102, for example in a user interface of the client application 104 running or otherwise executing on the user device 102.

While the numerical simulator application 121 and the frequency domain neural network 123 are illustrated as being executed by a computing device (e.g., server) 106, the numerical simulator application 121 and/or the frequency domain neural network 123 may be at least partially executed at a client application 104. For example, the computing device 106 may be configured to train the frequency domain neural network 123, and the trained frequency domain neural network 123 may be executed locally at a client application 104. Moreover, the numerical simulator application 121 may at least partially reside at the client application 104.

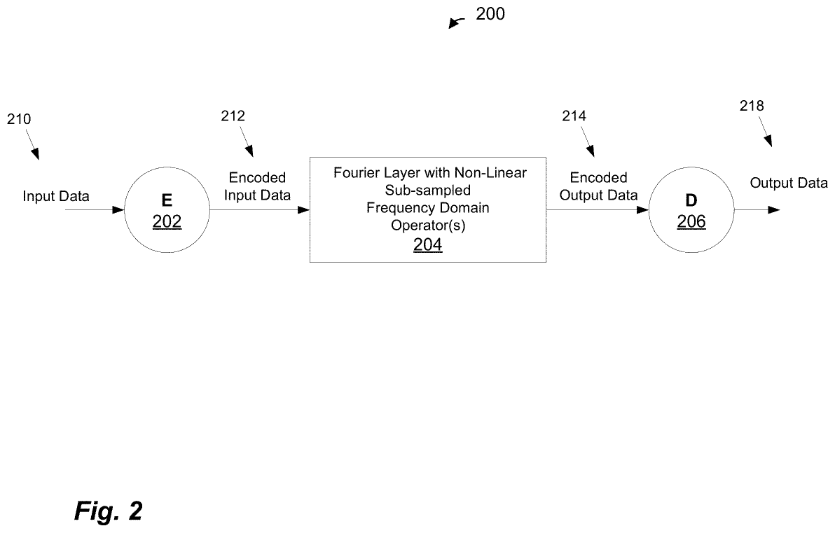

FIG. 2 is a block diagram depicting an example implementation of a frequency domain neural network 200, in accordance with aspects of the present disclosure. In aspects, the frequency domain neural network 200 may correspond to the frequency domain neural network 123 of system 100 of FIG. 1. In other aspects, the frequency domain neural network 200 may be utilized with a system different from the system 100 of FIG. 1.

The frequency domain neural network 200 may include an encoder 202, a frequency domain layer 204 and a decoder 206. The encoder 202 may be configured to encode input data 210, such as input parameter(s), to generate encoded input data 212. For example, the encoder 202 may perform a convolution (e.g., 1×1 convolution) to increase channel dimensionality of the input data. The encoded input 212 may be processed by the frequency domain layer 204 to generate encoded output data 214. Processing of the encoded input data 212 by the frequency domain layer 204 may include transforming the encoded data into frequency domain. Transformation of the encoded input data 214 to the frequency domain may include generating a plurality of frequency modes of the encoded input data 212 in the frequency domain. In aspects, Fourier transform, such as discrete Fourier transform (DFT), may be applied to the encoded input data 212 to generate the plurality of frequency modes of the encoded input data 212. In other aspects, other suitable transformations (e.g., a discrete wavelet transform, a Hartley transform, a Curvelet transform, etc.) may be applied to the encoded input data. After frequency domain transformation, dimensionality of the encoded input data 212 may be reduced in the frequency domain by sub-sampling the plurality of frequency modes of the encoded input data 212 in the frequency domain. In an aspect, only a subset of the frequency modes of the encoded input data 212 in the frequency domain data may be kept, and the remaining frequency modes may be discarded. The subset of the plurality of modes in the frequency domain may include the fundamental frequency mode and one or more relatively higher-order frequency modes, whereas one or more relatively lower-order frequency modes may be discarded, for example.

The frequency domain layer 204 may be configured to perform linear operations on the sub-sampled input data. The single frequency domain layer 204 may also be configured to introduce non-linearity into the sub-sampled input data. For example, the single frequency domain layer 204 may include a plurality of stages, each stage i) performing a linear operation to apply a set of learnable weights (e.g., complex weights) to the sub-sampled frequency modes of the encoded input data 212 and ii) applying a non-linear transformation to the sub-sampled frequency modes of the encoded input data 212. In another aspect, each stage of the frequency domain layer 204 may apply a non-linear transformation to its sub-sampled frequency modes prior to performing a linear operation to apply a set of weights to the transformed sub-sampled frequency modes.

With continued reference to FIG. 2, in an aspect, the output of the last stage of the one or more stages of the frequency domain layer 204 may be up-sampled to generate encoded output data 214 having the original dimensions of the encoded input data 212 in the frequency domain. For example, zero-padding may be used to up-sample the data at the output of the last stage of the one or more stages of the frequency domain layer 204. Then, inverse frequency transformation (e.g., an inverse discrete Fourier transform (IDFT), an inverse discrete wavelet transform, an inverse Hartley transform, an inverse Curvelet transform, etc.) may be applied to the up-sampled output data to generate time and/or spatial domain encoded output data 214. The time and/or spatial domain encoded output data 214 may be provided to the decoder 206 which may, in turn, decode the encoded output data 214 to generate output data 218, such as simulated output. In an aspect, the decoder 206 may perform a convolution (e.g., 1×1 convolution) to transform the time and/or spatial domain encoded output data 214 data back to the original dimensions of the input channel. Because only a single frequency domain transform is performed on the full dimensional input data 212 and only one inverse frequency transform is performed on the full dimensional output data 214, the frequency domain neural network 200 may be implemented with less computational cost as compared to a conventional frequency domain neural network, such as a conventional FNO. The reduced computational cost may in turn allow the frequency domain neural network 200 to scale to numerical simulations with increased dimensionality, such as three-dimensional or four-dimensional numerical simulations, for example.

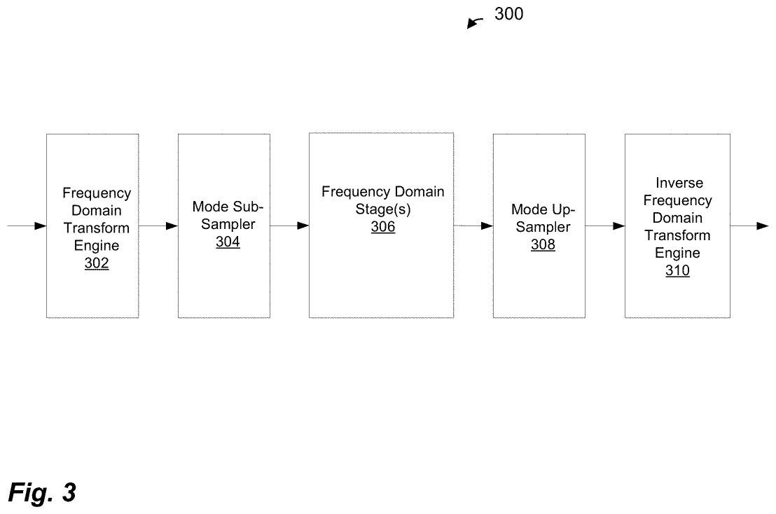

FIG. 3 is a block diagram depicting an example implementation of a frequency domain layer 300, in accordance with aspects of the present disclosure. The frequency domain layer 300 may correspond to the frequency domain layer 204 of FIG. 2. The frequency domain layer 300 may include a frequency domain transform engine 302, a frequency mode sub-sampler 304, one or more frequency domain stages 306, a mode up-sampler 308 and an inverse frequency transform engine 310. The frequency domain transform engine 302 may transform input data (e.g., encoded input data 212) into frequency domain. The frequency domain transform engine 302 may, for example, implement a DFT to transform the input data into the frequency domain. Transforming the input data into the frequency domain may involve generating a plurality of frequency modes of the input data in the frequency domain. The sub-sampler 304 may sub-sample the input data in the frequency domain. For example, the sub-sampler 304 may sub-sample the input data in the frequency domain by keeping only a subset of lower-indexed frequency modes (e.g., the first k frequency modes) and discarding higher-indexed frequency modes. In other aspects, the sub-sampler 304 may implement other suitable sub-sampling techniques.

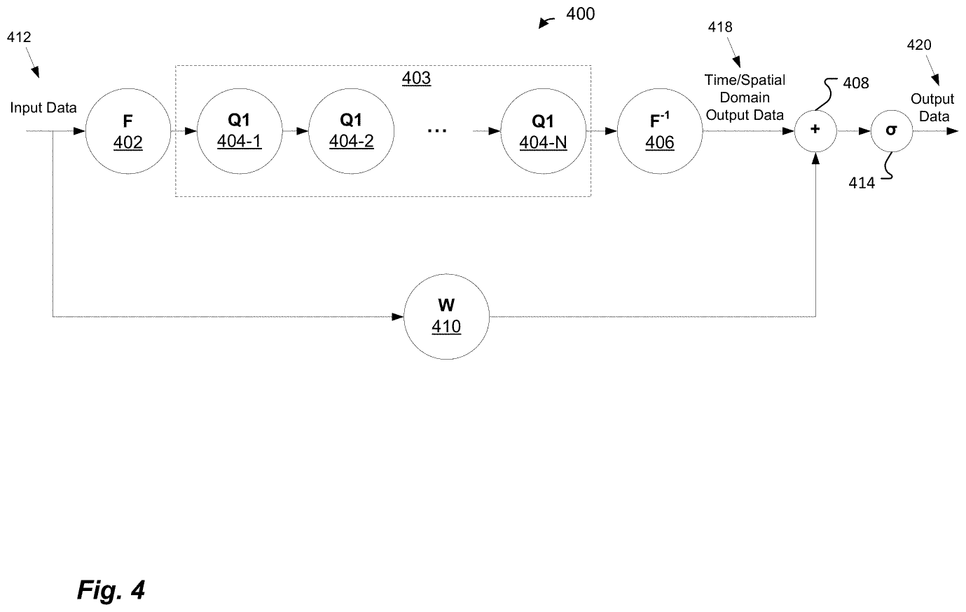

The sub-sampled input data may be successively processed by one or more frequency domain stages 306. Each of the one or more frequency domain stages 306 may apply a non-linear transformation to the sub-sampled data processed in the frequency domain stage 306. In an aspect, each of the one or more frequency domain stage 306 may i) perform a linear operation to apply a set of weights to the sub-sampled frequency modes of the input data and ii) apply a non-linear transformation to the sub-sampled frequency modes of the input data. Thus, non-linearities may be introduced by the one or more frequency domain stages 306 into the sub-sampled dimensionality data via convolutions that may be performed on the sub-sampled dimensionality data. Example implementation of quadratic non-linearities that may be implemented in the one or more frequency domain stages 306, according to an example aspect, is described below with reference to FIG. 4. In other aspects, quadratic non-linearities may be implemented in other suitable manners and/or non-quadratic non-linearities (e.g., cubic, power of 4, etc.) or other types of non-linearities may be performed on the sub-sampled dimensionality data in each of the one or more frequency domain stages 306.

Output data at the output of the last stage 306 of the one or more stages 306 may be provided to the mode up-sampler 308. The mode up-sampler 308 may up-sample the output data at the output of the last stage 306 to produce output data of the original (before sub-sampling by the mode sub-sampler 304) dimensionality (having the original number of frequency modes) of the input data in the frequency domain. In an aspect, the mode up-sampler 308 may implement zero-padding to up-sample the output data at the output of the last stage 306. In another aspect, another suitable up-sampling technique may be utilized. The up-sampled output data may be operated on by the inverse frequency domain transform engine 310. The inverse frequency domain transform engine 310 (e.g., an IDFT engine) may transform the up-sampled output data back into the time and/or spatial domain to produce output data (e.g., the encoded output data 214).

FIG. 4 is a block diagram depicting an example implementation of a frequency domain layer 400 in more detail, in accordance with aspects of the present disclosure. In aspects, the frequency domain layer 400 corresponds to the frequency domain layer 204 of FIG. 2 and/or the frequency domain layer 300 of FIG. 3. The frequency domain layer 400 includes a frequency transform engine 402 that may correspond to the frequency domain transform engine 302. The frequency transform engine 402 may transform input data 412 (e.g., corresponding to encoded input data 212) into frequency domain by generating a plurality of frequency modes of the input data 412 in the frequency domain. The plurality of modes generated by the frequency transform engine 402 may be sub-sampled as described above to reduce dimensionality of the input data 412 in the frequency domain. The sub-sampled frequency modes may be provided to a frequency layer 403 having a plurality of stages 404-1 through 404-N, including one or more hidden stages 404. In an aspect, each stage 404 may apply a non-linear transformation to the reduced dimensionality, sub-sampled, data. In an aspect, each stage 404 may i) perform a linear multiplication of reduced dimensionality, sub-sampled, data with a set of weights corresponding to the stage 404 and ii) applying a non-linear transformation to the reduced dimensionality, sub-sampled, data. The non-linear transformation may be a quadratic transformation, for example. In other aspects, the non-linear transformation may comprise another suitable type, such as a power of three (cubic) transformation, a power of four transformation, etc. In other aspects, other suitable non-linear transformations to the reduced dimensionality, sub-sampled, data may be applied.

In an example in which the non-linear transformation applied to the reduced dimensionality, sub-sampled, data is a quadratic transformation, each stage 404 may operate according to

yₖ=wₖ⊙xₖ+ [symbol] ( [symbol] ⁻¹(aₖ⊙xₖ)⊙ [symbol] ⁻¹(bₖ⊙xₖ))+ [symbol] ( [symbol] ⁻¹(cₖ⊙xₖ)⊙ [symbol] ⁻¹(dₖ⊙xₖ)) k=1, . . . ,n_{modes} Equation 1.

In this example, sub-sampled input data is provided to the stage 404, and each mode of the sub-sampled data xₖ is element-wise multiplied with a set of learned weights wₖ to perform linear multiplication in the stage 404, where k is a frequency mode index. Additionally, a quadratic transformation may be performed in the stage 404. Performing the quadratic transformation may include a plurality of element-wise multiplications to apply learned weights aₖ, bₖ, cₖ, dₖ to the sub-sampled input data xₖ. The sub-sampled data weighted with the weights aₖ and bₖ may be transformed to time and/or spatial domain, and element-wise multiplication may be performed on the sub-sampled data in the time and/or spatial domain. The resulting sub-sampled data may then be transformed back to the frequency domain. Similarly, the sub-sampled data weighted with the weights cₖ and dₖ may be transformed to time and/or spatial domain, element-wise multiplication may be performed on the sub-sampled data in the time and/or spatial domain, and the resulting sub-sampled data may then be transformed back to the frequency domain. The output of the stage 404 may be the result of an addition between i) the sub-sampled data weighted by the weights aₖ and bₖ and transformed back to the frequency domain and ii) the sub-sampled data weighted by the weights cₖ and dₖ and transformed back to the frequency domain, in accordance with Equation 1. In other aspects that utilize quadratic transformation in the stages 404, the quadratic transformations may be performed in other suitable manners.

With continued reference to FIG. 4, the output of the last stage 404-N may be up-sampled to produce a frequency domain output having the dimensions equal to the original dimensions of the input data 412 after conversion into the frequency domain. For example, zero-padding may be added to the output of the last stage 404-N to produce a frequency domain output having the dimensions equal to the original dimensions of the input data 412 after conversion into the frequency domain. In other aspects, other suitable up-sampling techniques may be employed. The up-sampled frequency domain output may be transformed back the time and/or spatial domain by an inverse frequency transform engine 406. For example, an inverse Fourier transform may be performed by the inverse frequency transform engine 406. In some aspects, a linear transform W 410 (e.g., 1×1 convolution) may be applied to the time and/or frequency domain input data 412, and the result may be added to the time and/or spatial domain output 418 by a summer 408 to produce output data 420. In some aspects, a time and/or spatial domain non-linear activation function σ 414 may apply a point-wise non-linear transformation to the resulting time and/or spatial domain output to produce output data 420. The time and/or frequency domain non-linear activation function σ 414 may comprise a rectified linear unit (ReLU). In other aspects, other suitable non-linear activation functions may be utilized.

In aspects, training of a frequency domain layer, such as the frequency domain layer 400, may be performed using common deep learning libraries such as PyTorch, TensorFlow, Caffe, MXNet, or with conventional linear algebra packages such as Numpy. Training of the frequency domain layer, such as frequency domain layer 400 may include learning of weights, such as weights aₖ, bₖ, cₖ, dₖ to be applied to sub-sampled data. Training of the network may involve supervised training in which the data misfit (e.g., L2-norm) between the network output and training data is minimized using convex optimization algorithms (e.g., stochastic gradient descent, ADAM, etc.). In aspects, training may be performed based on training data generated using numerical solvers to salve differential equations. In other aspects, other suitable training methods may be employed. In aspects, a trained model (e.g., weights aₖ, bₖ, cₖ, dₖ) may be saved in a memory, such as the memory 120 or another memory included in or otherwise accessible (e.g., via the network 108) by the server 106, and may subsequently be retrieved from the memory (e.g., by the numerical simulation application 121) and utilized for performing numerical simulations.

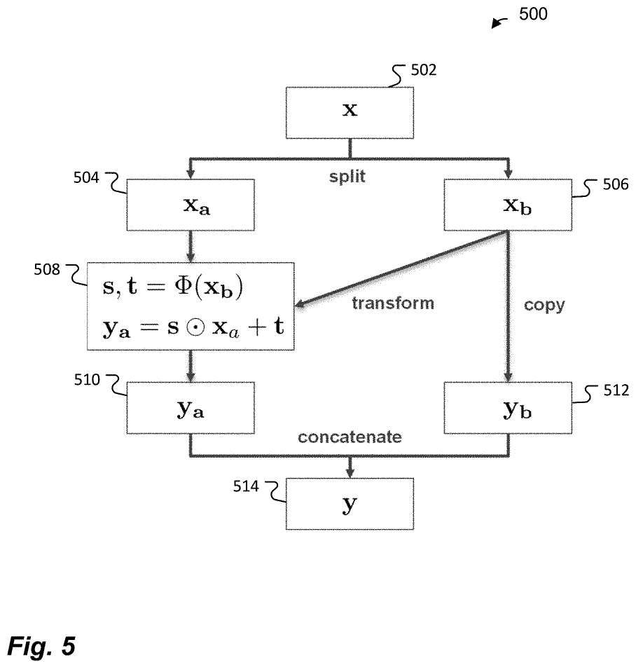

In an aspect, because dimensionality of data does not change between respective hidden stages 404, the stages 404 may be implemented using invertible coupling layers. In this aspect, trained parameters in the hidden stages 404 may be recomputed during training and are not stored in the forward training pass. FIG. 5 is a block diagram depicting an example implementation of the stages 404 using invertible coupling layers, according to an aspect of the present disclosure. In this example, an input x 502 is split into a first branch input xₐ 504 and a second branch input x_{b} 506. The first branch input xₐ 504 is element-wise multiplied with a function Φ (e.g., Equation 1) applied to the second branch input x_{b} 506 to generate a first branch output yₐ 510. In parallel, the second branch input x_{b} 506 is copied to a second branch output y_{b} 512. The first branch output yₐ 510 and the second branch input y_{b} 512 are then concatenated to generate an output y 514 of the stage 404.

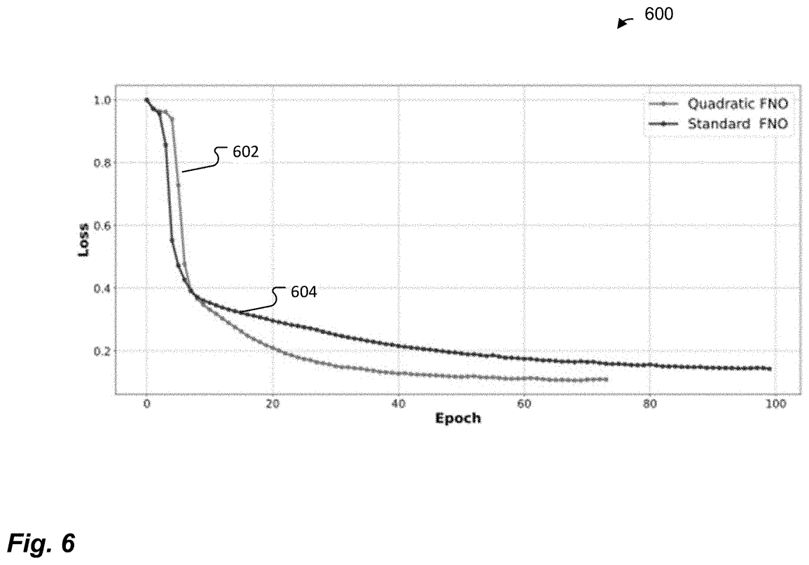

FIG. 6 is a plot 600 depicting convergence in training of a frequency domain neural network with sub-sampled non-linear transformations, in accordance with aspects of the present disclosure. The plot 600 illustrates a convergence plot 602 of a frequency domain neural network with sub-sampled non-linear transformations, such as the frequency domain neural network 123, in accordance with an aspect of the present disclosure. The plot 600 also illustrates a convergence plot 604 of a conventional frequency domain neural network, such as a conventional FNO. As can be seen from plots 602, 604, a frequency domain neural network with sub-sampled non-linear transformations as described herein may converge faster than a conventional frequency domain neural network, such as a conventional FNO. That is, in at least some aspects, fewer training epochs may be needed to train a frequency domain neural network with sub-sampled non-linear transformations as described herein as compared to a conventional frequency domain neural network, such as a conventional FNO.

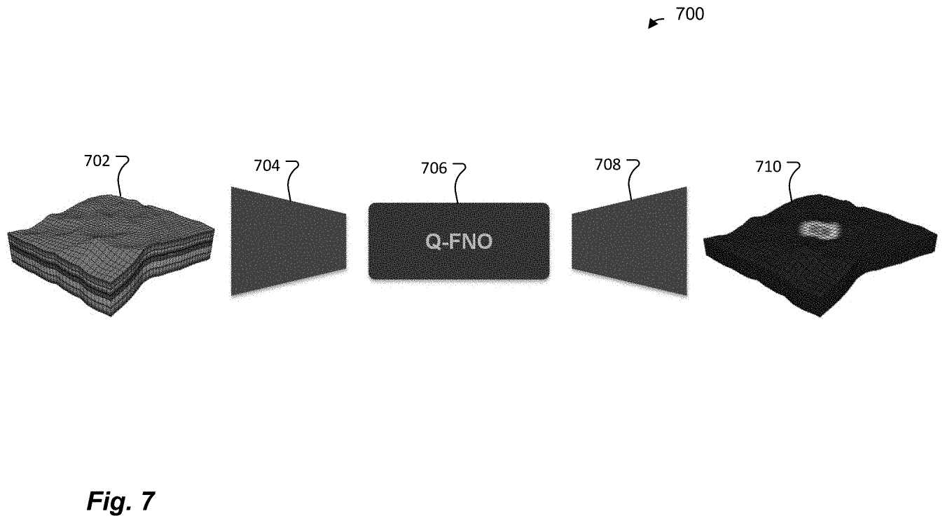

FIG. 7 is a diagram depicting operation of a frequency domain neural network 700 with sub-sampled non-linear transformations, in accordance with aspects of the present disclosure. The frequency domain neural network 700 may model CO₂ flow, for example. The frequency domain neural network 700 may receive input data 702. Input data 702 may be multi-dimensional grid data for example. The input data 702 may comprise input parameters such as parameters of a reservoir into which CO₂ is injected, rock properties (e.g., rock permeability), injections parameters (e.g., injection well physical dimensions), etc. An input transform block 704 may encode the input data 702 and may transform the input data 702 into frequency domain. The input transform block 704 may also reduce dimensionality of the input data 702 in frequency domain, for example by keeping only a subset of relatively higher frequency modes of the input data 702 in the frequency domain. The sub-sampled data in the frequency domain may be processed by a frequency layer 706, which may include a plurality of stages configured to i) perform a linear multiplication of reduced dimensionality data with a set of weights and ii) apply a non-linear (e.g., transformation) transformation to the sub-sampled data as described herein. An output transformation block 708 may up-sample the output of the last stage of the frequency layer 706, and may transform the resulting data to the time and/or spatial domain to generate output data 710. The output data 710 may represent simulated CO₂ saturation and pressure in the subsurface as a function of time.

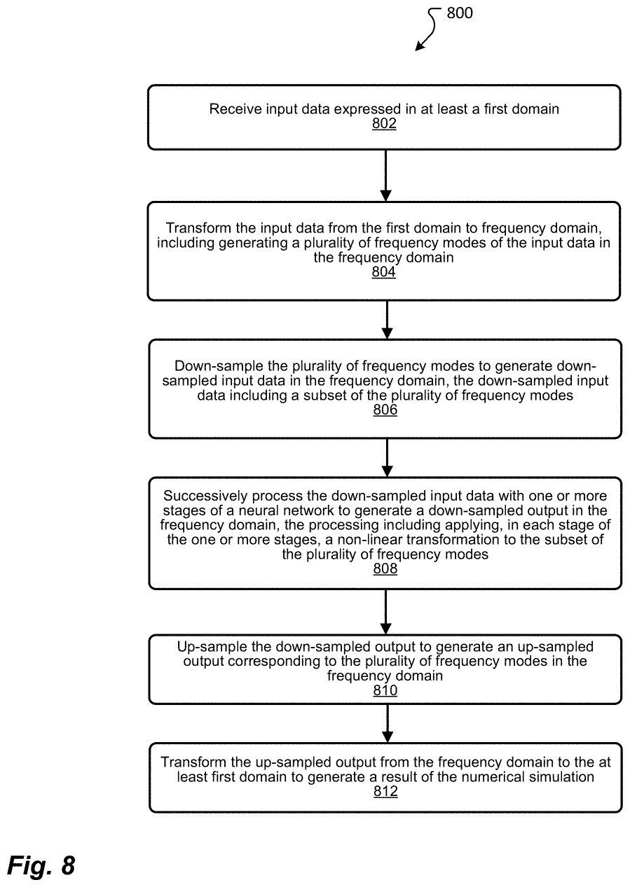

FIG. 8 is a block diagram of an example method 800 for performing a numerical simulation, in accordance with aspects of the present disclosure. A general order for the steps of the method 800 is shown in FIG. 8. The method 800 can be executed as a set of computer-executable instructions executed by a computer system and encoded or stored on a computer readable medium. Further, the method 800 can be performed by gates or circuits associated with a processor, Application Specific Integrated Circuit (ASIC), a field programmable gate array (FPGA), a system on chip (SOC), or other hardware device. Hereinafter, the method 800 shall be explained with reference to the systems, components, modules, software, data structures, user interfaces, etc. described in conjunction with FIGS. 1-7.

At block 802, input data is received. The input data may be expressed in at least a first domain. The at least the first domain may comprise time and/or spatial domain, for example. The input data may be multi-dimensional grid data, for example. In an aspect, the input data may comprise one or more parameters of a CO₂ injection site for which CO₂ flow modeling is to be performed. In another aspect, the input data may comprise one or more parameters of a physical space in which propagation of a Wi-Fi signal is to be modeled. In other aspects, the input data may comprise other input parameters for performing other suitable simulations, such as wave propagation, fluid flow, heat transfer, etc.

At block 804, the input data received at block 802 is transformed from the first domain to frequency domain. In an aspect, transforming the input data at block 802 includes generating a plurality of frequency modes of the input data in the frequency domain. For example, a discrete Fourier transform (DFT) is applied to the input data to generate a plurality of frequency modes of the input data in the frequency domain. In other aspects, other suitable other suitable transformations may be applied to transform the input data. Such transformations may include, but are not limited to, a discrete wavelet transform, a Hartley transform, a Curvelet transform, etc.

At block 806, the plurality of frequency modes are down-sampled to generate down-sampled input data in the frequency domain. In an aspect, the down-sampled input data includes a subset of the plurality of frequency modes. Down-sampling at block 806 may comprise keeping a subset of relatively higher-order frequency modes and discarding relatively lower-order frequency modes. In other aspects, other down-sampling techniques may be utilized.

At block 808, the down-sampled input data is successively processed with one or more stages of a neural network to generate a down-sampled output in the frequency domain. In an aspect, the processing at block 808 includes applying, in each stage of the one or more stages, a non-linear transformation to the subset of the plurality of frequency modes. In an aspect, the non-linear transformation comprises a quadratic non-linear transformation, for example as described above with reference to FIG. 4. In other aspects, other types of non-linear transformations may be applied.

At block 810, the down-sampled output is up-sampled to generate an up-sampled output corresponding to the plurality of frequency modes in the frequency domain. For example, zero-padding is implemented to up-sample the data. In other aspects, other suitable up-sampling techniques may be utilized.

At block 812, the up-sampled output is transformed from the frequency domain to the at least the first domain to generate a result of the numerical simulation. The result of the numerical simulation may comprise simulated flow of CO₂ in an injection site or simulated Wi-Fi signal strength in a physical space, for example.

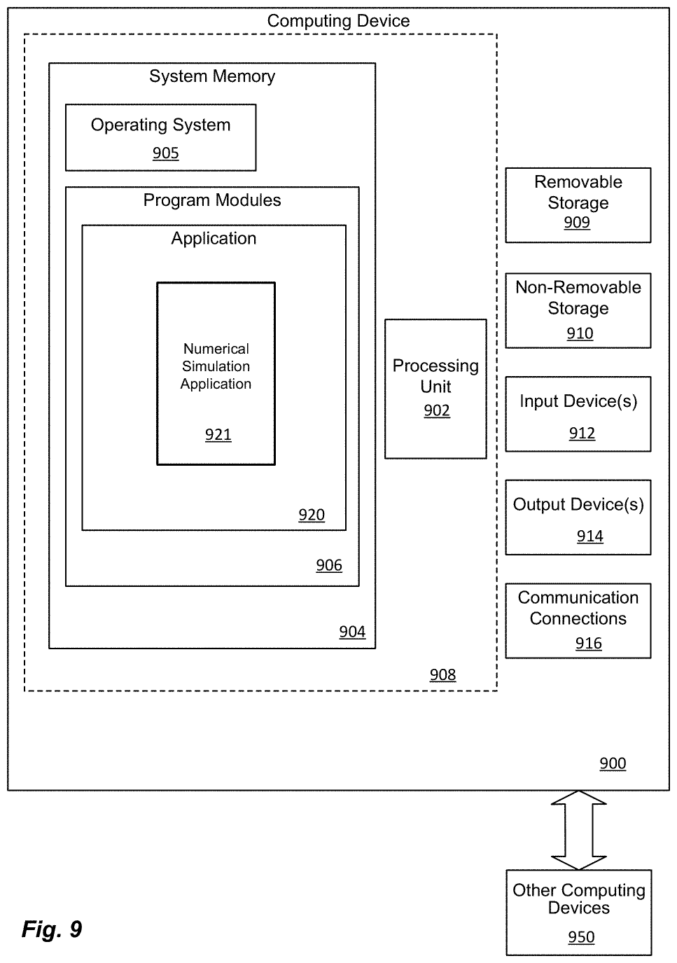

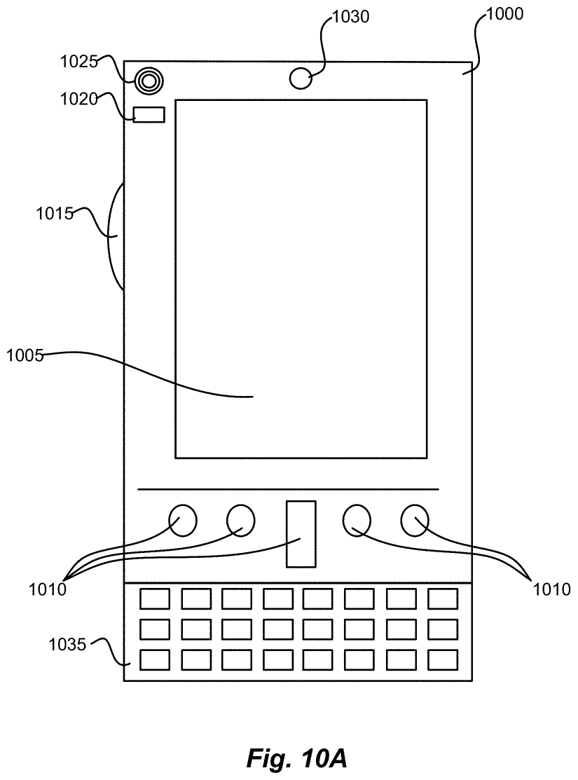

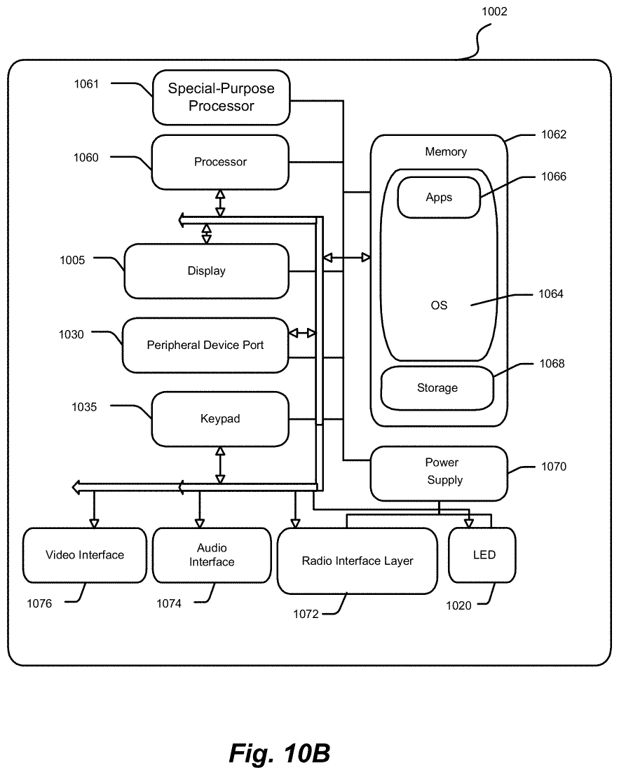

FIGS. 9-10 and the associated descriptions provide a discussion of a variety of operating environments in which aspects of the disclosure may be practiced. However, the devices and systems illustrated and discussed with respect to FIGS. 9-10 are for purposes of example and illustration and are not limiting of a vast number of computing device configurations that may be utilized for practicing aspects of the disclosure, described herein.

FIG. 9 is a block diagram illustrating physical components (e.g., hardware) of a computing device 900 with which aspects of the disclosure may be practiced. The computing device components described below may be suitable for the computing devices described above. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories.

The system memory 904 may include an operating system 905 and one or more program modules 906 suitable for running software application 920, such as one or more components supported by the systems described herein. As examples, system memory 904 may store a numerical simulator application 921 (e.g., corresponding to the numerical simulator application 121 of FIG. 1). The operating system 905, for example, may be suitable for controlling the operation of the computing device 900.

Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the at least one processing unit 902, the program modules 906 (e.g., application 920) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 10A-10B illustrate a mobile computing device 1000, for example, a mobile telephone, a smart phone, wearable computer (such as a smart watch), a tablet computer, a laptop computer, and the like, with which aspects of the disclosure may be practiced. In some aspects, the client (e.g., client device 102A, 102B) may be a mobile computing device. With reference to FIG. 10A, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display). If included, an optional side input element 1015 allows further user input. The side input element 1015 may be a rotary switch, a button, or any other type of manual input element. In alternative aspects, mobile computing device 1000 may incorporate more or less input elements. For example, the display 1005 may not be a touch screen in some aspects. In yet another alternative aspect, the mobile computing device 1000 is a portable phone system, such as a cellular phone. The mobile computing device 1000 may also include an optional keypad 1035. Optional keypad 1035 may be a physical keypad or a “soft” keypad generated on the touch screen display. In various aspects, the output elements include the display 1005 for showing a graphical user interface (GUI), a visual indicator 1020 (e.g., a light emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external source.

FIG. 10B is a block diagram illustrating the architecture of one aspect of computing device, a server, or a mobile computing device. That is, the computing device 1000 can incorporate a system (e.g., an architecture) 1002 to implement some aspects. The system 1002 can implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., search engine, extractor module, relevancy ranking module, answer scoring module, etc.).

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated configuration, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with aspects of the present disclosure, the microphone may also serve as an audio sensor to facilitate control of notifications, as will be described below. The system 1002 may further include a video interface 1076 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for performing a numerical simulation, the method comprising:
receiving input data expressed in at least a first domain;
transforming the input data from the first domain to frequency domain, including generating a plurality of frequency modes of the input data in the frequency domain;
down-sampling the plurality of frequency modes to generate down-sampled input data in the frequency domain, the down-sampled input data including a subset of the plurality of frequency modes;
successively processing the down-sampled input data with one or more stages of a neural network to generate a down-sampled output in the frequency domain, the processing including applying, in each stage of the one or more stages, a non-linear transformation to the subset of the plurality of frequency modes;
up-sampling the down-sampled output to generate an up-sampled output corresponding to the plurality of frequency modes in the frequency domain; and
transforming the up-sampled output from the frequency domain to the at least the first domain to generate a result of the numerical simulation.

2. The method of claim 1, wherein:
transforming the input data to the frequency domain comprises applying a discrete Fourier transform (DFT) to the input data, and
transforming the up-sampled output data from the frequency domain to the first domain comprises applying an inverse DFT (IDFT) to the up-sampled output data.

3. The method of claim 1, wherein applying the non-linear transformation to the subset of the plurality of frequency modes comprises applying a quadratic transformation to the subset of the plurality of frequency modes.

4. The method of claim 1, wherein the input data is expressed in one or both of spatial domain and time domain.

5. The method of claim 1, wherein successively processing the down-sampled input data with one or more stages of the neural network to generate the down-sampled output in the frequency domain comprises successively processing the down-sampled input data with multiple stages of the neural network, the processing including applying, in each stage of the multiple stages, a non-linear transformation to the subset of the plurality of frequency modes.

6. The method of claim 1, wherein the one or more stages of the neural network are implemented using invertible coupling layers.

7. The method of claim 6, wherein
the input data comprises one or more parameters of a carbon dioxide (CO₂) injection site, and
the output data comprises one or both of saturation and pressure distribution of CO₂ as a function of time as CO₂ injected into the CO₂ site propagates in sub-surface at the CO₂ injection site.

8. A system, comprising:
one or more computer readable storage media; and
program instructions stored on the one or more computer readable storage media that, when executed by at least one processor, cause the at least one processor to:
receive training data for training a neural network to perform numerical simulations to model a physical phenomenon, the training data determined based on a solution of one or more differential equations that model the physical phenomenon,
train a neural network, based on the training data, to perform numerical simulations modeling the physical phenomenon, wherein the neural network includes multiple frequency domain stages configured to apply non-linear transformations to sub-sampled input data in frequency domain;
receive input data for a numerical simulation, the input data expressed in at least a first domain;
transform the input data from the first domain to frequency domain, including generating a plurality of frequency modes of the input data in the frequency domain;
down-sample the plurality of frequency modes to generate down-sampled input data in the frequency domain, the down-sampled input data including a subset of the plurality of frequency modes;
successively process the down-sampled input data with the multiple stages of the neural network to generate a down-sampled output in the frequency domain, the processing including applying, in each stage of the multiple stages, the non-linear transformation to the subset of the plurality of frequency modes;
up-sample the down-sampled output to generate an up-sampled output corresponding to the plurality of frequency modes in the frequency domain; and
transform the up-sampled output from the frequency domain to the at least the first domain to generate a result of the numerical simulation.

9. The system of claim 8, wherein the program instructions, when executed by the at least one processor, cause the at least one processor to
apply a discrete Fourier transform (DFT) to the input data to transform the input data to the frequency domain, and
applying an inverse DFT (IDFT) to the up-sampled output data to transform the up-sampled output data from the frequency domain.

10. The system of claim 8, wherein the program instructions, when executed by the at least one processor, cause the at least one processor to, in each of the multiple stages of the neural network, apply a quadratic transformation to the subset of the plurality of frequency modes.

11. The system of claim 8, wherein the input data is expressed in one or both of spatial domain and time domain.

12. The system of claim 8, wherein the one or more stages of the neural network are implemented using invertible coupling layers.

13. The system of claim 8, wherein the physical phenomenon is propagation of carbon dioxide (CO₂) in a sub-surface of a CO₂ injection site.

14. The system of claim 13, wherein
the input data comprises one or more parameters of the CO₂ injection site, and
the output data comprises one or both of saturation and pressure distribution of CO₂ as a function of time as CO₂ injected into the CO₂ site propagates in sub-surface at the CO₂ injection site.

15. A computer-readable storage medium storing computer-executable instructions that when executed by at least one processor cause a computer system to:
receive input data expressed in at least a first domain;
transform the input data from the first domain to frequency domain, including generating a plurality of frequency modes of the input data in the frequency domain;
down-sample the plurality of frequency modes to generate down-sampled input data in the frequency domain, the down-sampled input data including a subset of the plurality of frequency modes;
successively process the down-sampled input data with one or more stages of a neural network to generate a down-sampled output in the frequency domain, the processing including applying, in each stage of the one or more stages, a non-linear transformation to the subset of the plurality of frequency modes;
up-sample the down-sampled output to generate an up-sampled output corresponding to the plurality of frequency modes in the frequency domain; and
transform the up-sampled output from the frequency domain to the at least the first domain to generate a result of the numerical simulation.

16. The computer-readable storage medium of claim 15, wherein the instructions, when executed by the at least one processor, cause the computer system to
apply a discrete Fourier transform (DFT) to the input data to transform the input data to the frequency domain, and
applying an inverse DFT (IDFT) to the up-sampled output data to transform the up-sampled output data from the frequency domain.

17. The computer-readable storage medium of claim 15, wherein the instructions, when executed by the at least one processor, cause the computer system to, in each of the one or more stages of the neural network, apply a quadratic transformation to the subset of the plurality of frequency modes.

18. The computer-readable storage medium of claim 15, wherein the input data is expressed in one or both of spatial domain and time domain.

19. The computer-readable storage medium of claim 15, wherein the instructions, when executed by the at least one processor, cause the computer system to successively process the down-sampled input data with multiple stages of the neural network, the processing including performing, in each stage of the multiple stages, a non-linear transformation to the subset of the plurality of frequency modes.

20. The computer-readable storage medium of claim 15, wherein
the input data comprises one or more parameters of a carbon dioxide (CO₂) injection site, and
the output data comprises one or both of saturation and pressure distribution of CO₂ as a function of time as CO₂ injected into the CO₂ site propagates in sub-surface at the CO₂ injection site.
